(19) United States
(12) Patent Application Publication
(10) Pub. No.: US 2006/0242283 A1
(43) Pub. Date: Oct. 26, 2006

(54) System and method for managing local storage resources to reduce I/O demand in a storage area network

(75) Inventors: Sadiq Ahamed Shaik, Bangalore (IN); William Price Dawkins, Round Rock, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/231,668

(22) Filed: Sep. 21, 2005

(30) Foreign Application Priority Data
Apr. 21, 2005 (IN) 1006/DEL/2005

(51) Int. Cl. G06F 15/173

(52) U.S. Cl. 709/223

(57) ABSTRACT

An information handling system for managing local storage resources includes multiple client nodes, each with an associated local storage resource. An intelligent switch includes a read management module operable to receive a read request for a selected memory block from a client node and compare the read request with a read management table. The read management module sends a Unique ID associated with the selected memory block if the read management table indicates that the selected memory block is stored in a local storage resource. If the selected memory block is not stored in a local storage resource, the read management module assigns a Unique ID to the selected memory block and stores the Unique ID in the read management table if the. The local storage network monitor receives the Unique ID associated with the a requested memory block and broadcasts a request to the other client nodes to locate the requested memory block.

### FOREIGN PRIORITY

This application claims foreign priority to Indian Patent Application Number 1006/DEL/2005 filed Apr. 21, 2005.

### TECHNICAL FIELD

The present invention is related to the field of computer systems and more specifically to a system and method for managing local storage resources to reduce I/O demand in a storage area network.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems often utilize storage area networks (SANs) or other external storage systems to store and manage data. However, the storage capacity of external storage subsystems is growing significantly faster than their input/output (I/O) performance. This is often because the storage capacity of disk drives and other storage resources within SANs are increasing at a faster rate than their I/O performance of these components. As a result, a storage system servicing multiple clients in a SAN will often have more data storage capacity than required because the number of clients supported by the SAN is governed by I/O demand and not storage capacity.

### SUMMARY OF THE INVENTION

Therefore a need has arisen for a system and method for decreasing I/O demand on SANs.

A need has also arisen for an improved method for read requests to a SAN.

The present disclosure describes a system and method for reducing I/O demand on a SAN by utilizing local storage resources associated with client nodes. An intelligent switch is disclosed that monitors incoming read requests and determines whether a requesting client node can retrieve the requested memory block from a local storage resource.

In one aspect, an information handling system including a plurality of client nodes is disclosed. Each of the client nodes includes a local storage network monitor module and is in communication with a local storage resource. The plurality of client nodes is communicatively coupled with an intelligent switch, which is communicatively coupled with at least one network storage resource. The intelligent switch includes a read management module operable to receive a read request for a selected memory block from a client node and compare the read request with a read management table. The read management module sends a Unique ID associated with the selected memory block if the read management table indicates that the selected memory block is stored in a local storage resource. The local storage network monitor receives the Unique ID associated with the requested memory block and then broadcasts a request to the plurality of client nodes to locate the requested selected memory block. The read management module assigns a Unique ID to the selected memory block and stores the Unique ID in the read management table if the selected memory block is not stored in a local storage resource. The selected memory block is then retrieved from the network storage resource and transmitted to the client node.

In another aspect, an intelligent switch for managing read requests in a storage network is disclosed that includes a plurality of host ports for communicating with a plurality of client nodes, with each of the client nodes having a local storage network monitor module and each client node communicatively associated with a local storage resource. The intelligent switch also includes at least one storage port for communicating with at least one network storage resource and a read management module. The read management module is operable to receive a read request for a selected memory block from a client node and compare the read request with a read management table. The read management module sends a Unique ID associated with the selected memory block if the read management table indicates that the selected memory block is stored in a local storage resource or assigns a Unique ID to the selected memory block and stores the Unique ID in the read management table if the selected memory block is not stored in a local storage resource.

In another aspect, a method for managing read requests in a storage network is disclosed. The method includes receiving a read request for a selected memory block from a client node at a read management module of an intelligent switch and comparing the read request with a read management table. The method also includes sending a Unique ID associated with the selected memory block to a local storage network monitor of a requesting client node if the read management table indicates that the selected memory block is stored in a local storage resource or assigning a Unique ID to the selected memory block and storing the Unique ID in the read management table if the selected memory block is not stored in a local storage resource.

The present disclosure includes a number of important technical advantages. One technical advantage is providing a read manage module within an intelligent switch. This allows the system to monitor which data blocks may be available from local storage resources, thereby reducing demand on the SAN. Additional advantages will be apparent to those of skill in the art and from the figures, description and claims provided herein.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows a storage area network and multiple client nodes according to teachings of the present disclosure;

FIG. 2 shows a storage area network that incorporates local storage network monitors and a read management module according to teachings of the present disclosure;

FIG. 3 shows a local storage management table;

FIG. 4 is a flow diagram showing a method for managing read requests according to teachings of the present disclosure; and

FIG. 5 is a flow diagram showing a method for managing a reconnected client node according to teachings of the present disclosure.

### DETAILED DESCRIPTION OF THE INVENTION

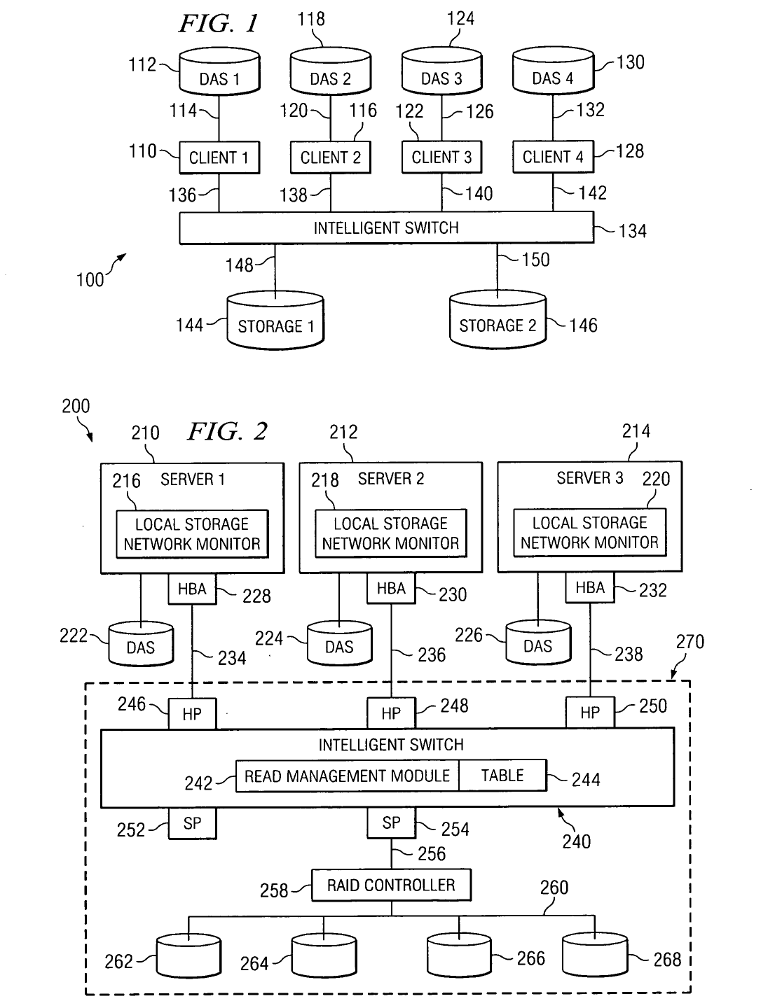

Preferred embodiments of the invention and its advantages are best understood by reference to FIGS. 1-5 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, a storage area network indicated generally at 100 is shown. Storage area network generally includes multiple client nodes 110, 116, 122 and 128 connected to a storage area network via intelligent switch 134. Each client node is also connected with a local storage resource 112, 118, 124 and 130, respectively.

Specifically, first client node 110 is in communication with local storage resource 112 via connection 114. Second client node 116 is in communication with second local storage resource 118 via connection 120. Third client node 122 is in communication with local storage resource 124 via connection 126. Fourth client node 128 is in communication with local storage resource 130 via connection 132.

The present embodiment includes four client nodes (110, 116, 122 and 128), however, the present disclosure contemplates systems that may include more or fewer client nodes. Also in the present embodiment, client nodes 110, 116, 122 and 128 may preferably comprise servers, however, in an alternative embodiments, client nodes 110, 116, 122 and 128 may include any suitable client node component. Also in the present embodiments, local storage resources 112, 118, 124 and 130 are each a direct attached storage (DAS) device that is associated with each respective client node. In an alternate embodiment, local storage resources 112, 118, 124 and 130 may comprise internal storage within client nodes 110, 116, 122 and 128 such that connections 114, 120, 126 and 132 may comprise internal connections.

Each of client nodes 110, 116, 122 and 128 are connected with intelligent switch 134. In the present embodiment, intelligent switch 134 may preferably comprises a fibre channel switch. In alternate embodiments, intelligent switch 134 may comprise any suitable hardware or software, including controlling logic, suitable for carrying out the functions described herein. In alternative embodiments, switch 134 may comprise Ethernet components using the internet Small Computer System Interface (iSCSI) protocol, Serial Attached SCSI (SAS) switches or Serial Advanced Technology Attachment (SATA) switches.

Intelligent switch 134 is connected with network storage resources 144 and 146. Intelligent switch 134 is connected with network storage resource 144 via connection 148. Intelligent switch 134 is connected with network storage resource 146 via connection 150. In the present embodiment, intelligent switch 134 and network storage resources 144 and 146 may be considered to be components of a storage area network which is in communication with client nodes 110, 116, 122 and 128.

In operation, client node 110 may send a read request to intelligent switch 134 requesting a selected memory block stored on either network storage resource 144 and 146. Intelligent switch 134 preferably includes a read management table (as described below) and compares the location of the requested memory block with the read management table. If the read management table indicates that a copy of the requested selected memory block is stored on one of the local storage resources (112, 118, 124 or 130), intelligent switch 134 sends a notification to first client node 110 that the requested memory block is stored within a local storage resource and provides a unique identifier (Unique ID) associated with the requested memory block. Client node 110 then sends a broadcast to all of the associated client nodes (116, 122 and 128), including the unique ID associated with the requested memory block in order to determine which local memory resource (118, 124 or 130) has a locally stored copy of the requested memory block. The client node which is currently storing the requested memory block (for example, client node 116) then sends a response to the first client node 110. Client node 110 then cooperates with the responding client node 116 to transfer the copy of the requested memory block from the responding client node 116 to first client node 110. Specifically in this example, the requested memory block is transferred from local storage resource 118 to local storage resource 112. After the transfer is complete, first client node 110 will retain a copy of the requested memory block in local storage resource 112 and the copy that had previously been stored on local storage resource 118 will be deleted. In this manner, at any given time, only a single copy of a memory block which has been read from the storage area network will preferably be stored within the plurality of local storage resources. Of course, the original memory block will also be stored on either network storage resource 144 or 146.

Now referring to FIG. 2, an information handling system indicated generally at 200 is shown. Information handling system 200 generally includes multiple servers 210, 212 and 214 in communication with storage area network (SAN) 270. First server 210 includes local storage network monitor 216 and host bus adapter (HBA) 228. First server 210 is in communication with local storage resource 222. In the present embodiment local storage resource 222 comprises direct attached storage (DAS).

Second server 212 includes local storage network monitor 218 and HBA 230. Second server 212 is in communication with local storage resource 224 which, in the present embodiment, is a DAS. Third server 214 includes local storage network monitor 220 and HBA 232. Third server 214 is in communication with local storage resource 222 which, in the present embodiment, is a DAS. The present embodiment includes three servers 210, 212 and 214. In alternate embodiments, information handling system 200 may include more or fewer servers in connection with storage area network 270.

Storage area network 270 includes intelligent switch 240 in communication with RAID controller 258 which, in turn, is in communication with network storage resources 262, 264, 266 and 268. In the present preferred embodiment, intelligent switch 240 is a fibre channel switch and may be referred to as “intelligent fibre channel switch 240.” However the present disclosure contemplates intelligent switch 134 comprising Ethernet components using iSCSI protocol, SAS switches or SATA switches.

Intelligent fibre channel switch 240 includes host ports 246, 248 and 250 which facilitate communication with servers 210, 212 and 214. Intelligent switch 240 also includes storage ports 252 and 254 which facilitate communication with RAID controller 258 or other network storage components. Intelligent switch 240 also includes read management module 242 and read management table 244.

In the present embodiment, host port 246 facilitates connection with HBA 228 and first server 210. Host port 248 facilitates connection with HBA 230 and second server 212 via connection 236. Host port 250 facilitates connection with HBA 232 and third server 214 via connection 238. In the present embodiment, connections 234, 236 and 238 may comprise any suitable connection for connecting servers 210, 212 and 214 with storage area network 270. However, in a preferred embodiment, connections 234, 236 and 238 may each be two gigabyte fibre channel connections. In alternate embodiments, connections 234, 236 and 238 may be any suitable connectors. Additionally, in some alternative embodiments SAN 270 may include additional switches within the network, provided that all read requests sent to RAID controller 258 pass through intelligent switch 240.

Storage port 254 connects fibre channel switch 240 with RAID controller 258 via connection 256. RAID controller 258 is further in communication with network storage resources 262, 264, 266 and 268 via connection 260. Connections 256 and 260 may be Ethernet, Fibre Channel, SAS, SATA, and SCSI or any other suitable connection. RAID controller 258 may be any suitable device for facilitating random access to data at the block level, such as, for example, a RAID controller, a hard disk, or a solid state disk.

Intelligent switch 240 also includes read management module 242 and read management table 244. Read management module 242 represents hardware or software, including controlling logic, that performs the functions described below. Read management module 242 may receive read requests from servers 210, 212 or 214. After receiving a read request, read module 242 compares the address of the memory block being requested to read management table 244 in order to determine whether a copy of the requested memory block is stored on a local storage resource. Read management table 244 (which also may be referred to as a local storage management table) lists the memory blocks that have been copied to a local storage resource and also indicates a corresponding Unique ID (unique ID) that has been assigned by read management module 242 to each memory block.

If the comparison of the address of the memory block with table 244 indicates that a copy of the memory block is stored within a local storage resource, read management module 242 sends a notification to the requesting server (in this example, first server 210) indicating that a copy of the requested memory block is stored in a local storage resource and provides the Unique ID that has been assigned to the requested memory block. In this example embodiment, this notification is sent to the local storage network monitor 216. Local storage network monitor 16 then broadcasts the Unique ID to the other servers (212 and 214) within the network in order to locate which server's local storage resource is currently storing the requested memory block. In this example, the requested memory block is stored in local storage resource 224. Local storage network monitor 218 monitors the Unique IDs of the memory blocks stored in local storing resource 224 (or alternatively, may query local storage resource 224 to determine the memory blocks stored thereon). Local storage network monitor 218 preferably sends a response to the requesting server 210 local storage network monitor 216 indicating that a copy of the requested memory block is located on local storage resource 224. The local storage network monitors 216 and 218 then negotiate the transfer of the requested memory block from local storage resource 218 to local storage resource 216.

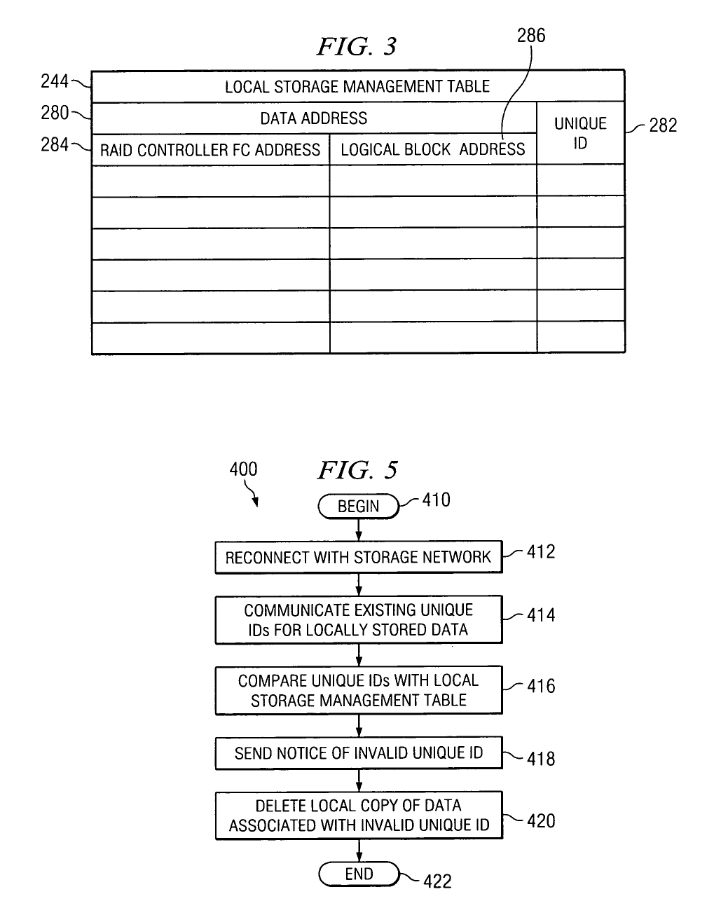

Now referring to FIG. 3, a local storage management table 244 is shown. Local storage management table 244 includes columns for maintaining information relating to memory blocks which may be requested by associated client nodes and Unique IDs which have been assigned to those memory blocks. Accordingly, local storage management table includes data address columns 280 and Unique ID column 282. In the present particular embodiment, data address information 280 more specifically includes both raid controller fibre channel address 284 and a logical block address 286. In alternative embodiments, data address, information 280 may include any address information that allows a requested memory block to be identified. Local storage management table 244 facilitates the operation of read management module 242 by allowing comparison of data address information 280 of incoming read requests and identifying Unique IDs 282 which have been assigned to a particular requested memory block. Read management module 242 is able to update local storage management table 244 in order to assign new Unique IDs 282 to newly read and copied memory blocks or to delete invalid Unique IDs 282.

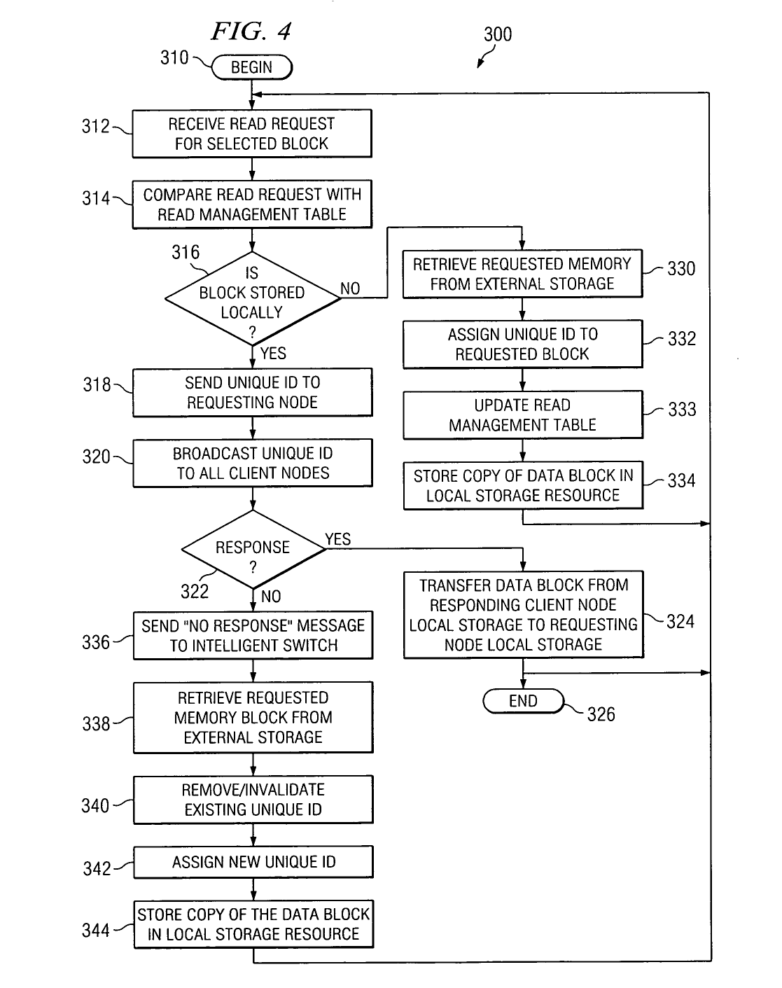

Now referring to FIG. 4, a flow diagram indicated generally at 300 depicts a method according to an embodiment of the present disclosure. The method begins at 310 when a read request for a selected memory block is received 312. The read request is sent from a client node such as first server 210 and received at read management module 242. The read request is then compared with a read management table 314 to determine whether the requested memory block is stored within a local storage resource 316. If the read management table indicates that the requested memory block is stored locally, the Unique ID associated with the requested memory block is sent to the requesting node 318. For instance, read management module 242 may send the Unique ID associated with the requested memory block to local storage network monitor 216 of first server 210. The Unique ID of the requested memory block is then broadcast to all of the other client nodes within the network 320. For instance, local storage network monitor 216 may then broadcast the Unique ID to local storage network monitors 218 and 220 using the Fibre Channel broadcast address 0xFFFFFF. Local storage network monitor 216 would then await a response to the broadcast 322.

If, for instance, local storage network monitor 218 associated with second server 212 sends a response indicating that it has a copy of the requested memory block. The requested memory block is then transferred from local storage resource of the responding client node to the local storage resource of the requesting node.

The method then proceeds to either ending or read management module 242 awaits the receipt of another read request.

In the event that after receiving the read request 312 and comparing the read request with the read management table 314 it is determined that the requested memory block is not stored in a local storage resource, read management module 242 allows the read request to proceed to raid controller 258 and network storage resources 262, 264, 266 and 268 as appropriate to retrieve the requested memory block 330. Read management module 242 then assigns a Unique ID to the requested memory block 332 and updates the new management table appropriately 333. A copy of the requested memory block is then stored in the local storage resource associated with the requesting client node 334. For instance, if the read request has initiated first server 210, a copy of the requested memory block would be stored in DAS 222 and local storage network monitor 216 records the Unique ID associated with that stored memory block. Any changes made to the copy of the requested memory block stored on DAS 222 are preferably synchronized with the corresponding copy of the memory block stored on the network storage resource.

One advantage of this method is that the load on the network storage resources (such as 144, 146, 262, 264, 266 and 268) is reduced since the requests are diverted to local storage resources. Also if the same memory block is required by the client node who has accessed it last, the access does not burden the network since it can get it directly from that client node's associated DAS. The storage of a local copy of a requested memory block also introduces an additional fault tolerance—if a network storage resource fails, any data stored in a local storage resource will still be accessible.

In the event that there is no response 322 to a broadcast of a Unique ID 320, the local storage network monitor 216 of the requesting server 210 then sends a “no response” message 336 to the intelligent switch component. This “no response” message is preferably sent to read management module 242. In this instance, read management module 242 then allows the read request to be transmitted to raid controller 258 to retrieve the requested memory block 338. The read management module 242 then either removes or invalidates the existing unique ID 340 and updates new management table 244 appropriately. Read management module 242 then assigns a new Unique ID 342 to the requested memory block and updates read management table 244 appropriately. A copy of the requested memory block is then sent to the requesting server where a copy of the requested data block is stored in local storage 344. As described above, the local storage network monitor associated with the requested server may also preferably store the Unique ID associated with the copy of the requested memory block.

Now referring to FIG. 5, a flow diagram showing method for reconnecting a server or client node with a storage network is shown. The method begins at 400 when a client node that had previously been connected with a storage network is reconnected 412. The client node communicates the Unique IDs that correspond to the memory blocks that are currently stored on its associated local storage resource 414. For instance, if first server 210 had previously been connected with SAN 270 and had become reconnected, local storage network monitor 216 would send the Unique IDs associated with the memory blocks stored within DAS 222. Next, read management module 242 compares the submitted Unique IDs with the read management table 416. Read management module 242 would then notify the reconnected server of any invalid Unique IDs 418. For instance, read management module 242 may send local storage network monitor 216 a notification that particular Unique IDs are invalid or no longer exist. The reconnected client node would then delete the local copy of the memory block associated with the invalid Unique ID 420, thereby ending method 422.

Although the disclosed embodiments have been described in detail, it should be understood that various changes, substitutions and alterations can be made to the embodiments without departing from their spirit and scope.

What is claimed is:

1. An information handling system comprising:
a plurality of client nodes, each of the client nodes having a local storage network monitor module and each client node communicatively associated with a local storage resource;
the plurality of client nodes communicatively coupled with an intelligent switch, the intelligent switch communicatively coupled with at least one network storage resource and having a read management module operable to:
receive a read request for a selected memory block from a client node;
compare the read request with a read management table;
send a Unique ID associated with the selected memory block if the read management table indicates that the selected memory block is stored in a local storage resource;
assign a Unique ID to the selected memory block and store the Unique ID in the read management table if the selected memory block is not stored in a local storage resource;
each local storage network monitor operable to:
receive a Unique ID associated with the a requested selected memory block; and
broadcast a request to the plurality of client nodes to locate the requested selected memory block.

2. The information handling system of claim 1 wherein the plurality of client nodes comprises a plurality of servers.

3. The information handling system of claim 1 wherein at least one local storage resource further comprises a direct attached storage (DAS) resource.

4. The information handling system of claim 1 wherein the intelligent switch comprises a fibre channel switch.

5. The information handling system of claim 1 further comprising a raid controller in communication with the intelligent switch and further in communication with at least one network storage resource.

6. The information handling system of claim 1 wherein the read management table comprises data address information and corresponding assigned unique ID information.

7. The information handling system of claim 6 wherein the read management table data address information comprises raid controller fibre channel address information and logical block address information.

8. The information handling system of claim 1 further comprising the local storage network monitor operable to request transfer of the selected memory block from a responding client node to a requesting client node.

9. The information handling system of claim 1 further comprising:
the local storage network monitor, after receiving no response to the broadcast, sending a “no response” message to the read management module;
the read management module operable to:
relay the original read request to the at least one network storage resource; and
update the read management table to remove the Unique ID and assign a new Unique ID to the selected memory block.

10. The information handling system of claim 9 further comprising the local storage network monitor module, after resuming communication with the intelligent switch, operable to:
communicate with the read management module to determine the validity of existing Unique IDs of data blocks stored on an associated local memory resource; and
delete any data blocks associated with invalid Unique IDs.

11. An intelligent switch for managing read requests in a storage network comprising:
a plurality of host ports for communicating with a plurality of client nodes, each of the client nodes having a local storage network monitor module and each client node communicatively associated with a local storage resource;
at least one storage port for communicating with at least one network storage resource;
a read management module operable to:
receive a read request for a selected memory block from a client node;
compare the read request with a read management table;
send a Unique ID associated with the selected memory block if the read management table indicates that the selected memory block is stored in a local storage resource; and
assign a Unique ID to the selected memory block and store the Unique ID in the read management table if the selected memory block is not stored in a local storage resource.

12. The intelligent switch of claim 11 wherein at least one local storage resource further comprises a direct attached storage (DAS) resource.

13. The intelligent switch of claim 11 wherein the intelligent switch comprises a fibre channel switch.

14. The intelligent switch of claim 11 wherein the read management table comprises data address information and corresponding assigned unique ID information.

15. The intelligent switch of claim 14 wherein the read management table data address information comprises raid controller fibre channel address information and logical block address information.

16. The intelligent switch of claim 11 further comprising the read management module operable to, after receiving a “no response” message from a client node:
relay the original read request to the at least one network storage resource; and
update the read management table to remove the Unique ID and assign a new Unique ID to the selected memory block.

17. A method for managing read requests in a storage network comprising:
receiving a read request for a selected memory block from a client node at a read management module of an intelligent switch;
comparing the read request with a read management table;
sending a Unique ID associated with the selected memory block to a local storage network monitor of a requesting client node if the read management table indicates that the selected memory block is stored in a local storage resource;
assigning a Unique ID to the selected memory block and storing the Unique ID in the read management table if the selected memory block is not stored in a local storage resource.

18. The method of claim 17 further comprising:
broadcasting the Unique ID from the local storage network monitor to a plurality of associated client nodes to locate the selected memory block; and
transferring the from the selected memory block to a local storage resource associated with the local storage network monitor.

19. The method of claim 17 further comprising:
sending a “no response” message to the read management module to the read management module after receiving no response to the broadcast;
completing the original read request from a network storage resource communicatively associated with the read management module; and
updating the read management table to remove the Unique ID and assign a new Unique ID to the selected memory block.

20. The method of claim 17 further comprising:
communicating with the read management module after resuming communication between a client node and the intelligent switch, to determine the validity of existing Unique IDs of data blocks stored on an associated local memory resource; and
deleting any data blocks associated with invalid Unique IDs.
